(19) United States
(12) Patent Application Publication
(10) Pub. No.: US 2022/0227197 A1
(43) Pub. Date: Jul. 21, 2022

(54) STABILIZER BAR FOR A CHASSIS OF A VEHICLE, PENDULUM SUPPORT FOR SUCH A STABILIZER BAR, AND METHOD FOR PRODUCING SUCH A STABILIZER BAR OR SUCH A PENDULUM SUPPORT

(71) Applicant: ZF Friedrichshafen AG, Friedrichshafen (DE)

(72) Inventors: Sebastian SCHLOTTER, Niederwerrn (DE); Johannes GESSNER, Euerbach (DE)

(21) Appl. No.: 17/608,375

(22) PCT Filed: Mar. 5, 2020
(86) PCT No.: PCT/EP2020/055790

§ 371 Date: Nov. 2, 2021

(30) Foreign Application Priority Data
May 9, 2019 (DE) 10 2019 206 726.3

(51) Int. Cl. B60G 21/055; B60G 7/00; F16C 11/06

(52) U.S. Cl. CPC B60G 21/0551; B60G 7/005; F16C 11/0623; F16C 11/0695; B60G 2204/1224; B60G 2204/416; F16C 2326/05; B60G 2206/427; B60G 2202/135; B60G 2204/422; B60G 2204/4307; B60G 2206/81012; B60G 2206/11

(57) ABSTRACT

A stabilizer for a chassis of a vehicle, having a curved stabilizer body (2) that forms a torsion spring, with a pendulum support (5, 6) and with a connecting section (7, 8, 46, 48), the connecting section (7, 8, 46, 48) is made of a metal and connects the stabilizer body (2) to the pendulum support (5, 6). The connecting section (7, 8, 46, 48) and the stabilizer body (2) are connected to one another by a snap-in and/or latch joint. To reduce assembly effort and expense and, at the same time, to join the stabilizer body (2) to the pendulum support (5, 6) in a secure manner, the stabilizer (1) and the pendulum support (5, 6) are characterized in that the connecting section has an opening (22) in which a plastic bearing shell (11) is arranged for fitting of a joint ball (23) of the pendulum support (5, 6).

This application is a National Stage completion of PCT/EP2020/055790 filed Mar. 5, 2020, which claims priority from German patent application serial no. 10 2019 206 726.3 filed May 9, 2019.

### FIELD OF THE INVENTION

The invention relates to a stabilizer for a chassis of a vehicle, having a curved stabilizer body that forms a torsion spring, with a pendulum support and with a connecting section, the said connecting section being made of a metal and connecting the stabilizer body to the pendulum support, wherein the connecting section and the stabilizer body are joined to one another by means of a snap-in or a latch connection. In addition, the invention relates to a pendulum support for such a stabilizer and to a method for producing such a stabilizer and such a pendulum support.

### BACKGROUND OF THE INVENTION

Such a stabilizer and such a pendulum support are known from DE 10 2016 205 916 A1. According to that document, the stabilizer has a curved basic body that forms a torsion spring which is made of fiber-reinforced plastic, and also has at least one connecting section arranged at its end for connecting the basic body to a pendulum support, wherein the connecting section is joined to the basic body by means of a snap-in connection. In this case, the basic body corresponds to the stabilizer body mentioned earlier.

Stabilizers of the type mentioned at the start are also called torsion-bar springs. Stabilizers or torsion-bar springs are widely known in automotive technology, in particular chassis engineering, for use as roll stabilizers. They are components which can be loaded in torsion, which reduce the rolling movements of a vehicle. To stabilize the rolling of vehicle bodies, stabilizers can be arranged between the wheels on an axle of a vehicle. During alternate deflection of the wheels on an axle, stabilizers distribute the axle load and thus ensure a uniform axle load distribution. Thereby, the driving behavior of a vehicle can be influenced in a positive manner in such a way that, for example, the coefficients of adhesion of the wheels arranged on an axle can always be kept almost identical and at a good level.

The free ends of known stabilizers can, in each case, usually be arranged on and/or supported by pendulum supports on a separate component, for example a wheel-guiding element such as a wheel carrier or a wheel-guiding control arm. In that case, the pendulum supports can be separate components. The connecting section joins the stabilizer body and the pendulum support to one another. Thus, the connecting section can be in the form of an intermediate part between the pendulum support, on the one hand, and the stabilizer, on the other hand.

### SUMMARY OF THE INVENTION

The purpose of the present invention is to develop further a stabilizer and a method of the type mentioned at the start, so as to reduce the assembly effort and, at the same time, so that the stabilizer can be connected to the pendulum support securely and simply. Preferably, the number of individual components, when fitting the stabilizer into a chassis of a vehicle, should be reduced. In particular, an alternative embodiment should be provided.

The objective on which the invention is based is achieved with a stabilizer and a pendulum support according to the independent claims. Preferred further developments of the invention are indicated in the subordinate claims and in the description that follows.

The stabilizer is designed for use in a chassis of a vehicle, in particular a motor vehicle. In this case, the stabilizer has a curved stabilizer body that forms a torsion spring. In particular, in the context of the present application a stabilizer body is understood to mean an elongated, strand-like, rod-like and/or tube-like body. Thus, the stabilizer body can be hollow or tubular, or made of solid material. In particular, the stabilizer body is in the form of a tubular rod or a solid rod. Owing to the curved design of the stabilizer body, it can essentially be U-shaped, C-shaped or curved in some other way. The stabilizer body can be made of more than one part. In particular, the stabilizer is designed as an active roll stabilizer, wherein the stabilizer body can comprise an actuator. The stabilizer body can be made in part or in full of a metal and/or a fiber-plastic composite. Furthermore, the stabilizer comprises at least one pendulum support and at least one connecting section. In particular, the stabilizer has two pendulum supports and two connecting sections, and, in each case, a pendulum support and a connecting section can be arranged at a free end of the stabilizer body. In particular, the stabilizer body has two ends remote from one another at each of which a pendulum support is arranged by way of a connecting section.

The connecting section is made of a metal. In particular, the connecting section is made of aluminum. Alternatively, from the prior art it is known to make the connecting section of plastic. However, in combination with a snap-in and/or latch joint for connecting the connecting section to the stabilizer body, it has been shown that with components made of plastic, such a snap-in and/or latch connection does not withstand higher loads and/or meet rigidity requirements to a sufficient extent. By means of a connecting section made of metal, or aluminum, however, the snap-in and/or latch connection withstands even strict demands for load-bearing ability and/or rigidity.

By means of the snap-in and/or latch connection, the connecting section and the stabilizer body can be connected to one another at the same time securely and simply. In particular, by virtue of the snap-in and/or latch connection a form-enclosed joint between the connecting section and the stabilizer body is produced. Depending on the structure of the snap-in and/or latch connection, the formed joint can optionally be releasable or permanent. In the case of a releasable joint, it is also simple to dismantle the stabilizer and/or the stabilizer body. The snap-in and/or latch connection can basically be made in various ways, wherein on at least one of the two elements, namely the connecting section or the stabilizer body, an elastically deformable securing element is provided which, when the two elements are joined together, detachably or permanently hooks and/or latches onto the respective other element. There is an interlock between the connecting section and the stabilizer body in the hooked and/or latched condition. The advantages of the snap-in and/or latch joint are simple and secure assembly on account of the fewer components to be joined, and the resulting cost savings. Moreover, dismantling is simple if a detachable snap-in and/or latch joint is used. With an appropriate design of the snap-in and/or latch joint assembly and/or dismantling can even be carried out without tools.

The connecting section has an opening in which a bearing shell of plastic for the movable fitting of a joint ball is arranged.

Here, it is advantageous that, by virtue of the plastic bearing shell, the pendulum support can be articulated directly to the connecting section in a simple manner. In particular, a movable and/or articulated fitting of the joint ball into the bearing shell means that the joint ball can pivot, tilt and/or rotate. Preferably, the co-operation of the joint ball and the bearing shell produces an articulated joint or hinge joint between the pendulum support and the connecting section. In particular, an articulated joint or hinged joint between two components denotes a connection between the two components by means of a joint of such a type that the two components, in this case the connecting section and the pendulum support, can be rotated relative to one another about at least one rotation axis. Thus, articulated or hinged joints can have exactly one rotation axis, exactly two rotation axes or exactly three rotation axes. Preferably, an articulated or hinged joint does not allow any translational movement of the two components relative to one another.

According to a further development, the bearing shell is held with interlock onto a rim of the said opening. In particular, the rim of the opening is circular or round. The bearing shell can essentially be shaped as part of a ball. In particular, an inner and/or an outer side of the bearing shell is shaped as part of a ball or sphere. The bearing shell can hold the rim of the opening and/or surround it with interlock. In particular, the rim of the opening is held with interlock in a groove-like seating of the bearing shell. In that way, the bearing shell is firmly connected to the rim of the opening, or the bearing shell is held onto the rim. Preferably, the rim of the opening has at least one notch into which the plastic of the bearing shell extends. By virtue of the at least one notch, twisting of the bearing shell within the opening, particularly about a central longitudinal axis of the opening, is impeded or blocked. Thus, a twist-resistant structure is formed with the notch in the edge of the opening and in combination with the bearing shell. Preferably, the rim of the opening has two notches, which can be arranged opposite one another or mirror-symmetrically to one another.

Preferably, the bearing shell has a bearing shell opening. The pendulum support, in particular the joint ball and/or a joint pin of the pendulum support connected to the joint ball, can extend out of the bearing shell opening. In particular, the joint ball is held captive inside the bearing shell. For that purpose, the bearing shell can extend beyond an equator of the joint ball, outward in the direction of the pendulum support and/or the joint pin. The size of the bearing shell opening is so as to ensure sufficient joint mobility, in particular pivoting and/or tilting mobility of the pendulum support. An opening rim of the bearing shell opening can have an all-round holding groove for receiving a rim of a sealing bellows. In that way, the articulated or hinged connection between the pendulum support and the connecting section can be protected by means of a sealing bellows against environmental influences such as contaminants, moisture, mechanical influences and the like. To fulfill that function, the sealing bellows can be formed from a flexible, in particular elastic material, preferably an elastomer, as a sleeve-like flexible body with two open ends. In this case, at an axial end facing toward the connecting section the sealing bellows can have a rim on the connecting section side, at an opposite end facing toward the pendulum support a rim on the pendulum support side, and a sheath connecting the said two ends. In principle, the sheath can be in various forms but, to ensure the mobility of the joint a contour, can be chosen so as to be both compressible and stretchable, such as a bulbous contour and/or a contour provided with folds. In the latter case, one speaks of a so-termed folding bellows, or if many folds are present, a multi-fold bellows.

In another further development, the bearing shell has a plurality of stiffening ribs on its outer circumference. The stiffening ribs can extend radially outward from a side of the bearing shell. In particular, the plurality of stiffening ribs are distributed uniformly in the circumferential direction around the bearing shell. The stiffening ribs are supported on the connecting section. In particular, the stiffening ribs are arranged on a side of the bearing shell facing away from the bearing shell opening and/or the connecting section. In other words, the stiffening ribs can be located on a side of the connecting section facing away from the pendulum support. Preferably, the stiffening ribs are made integrally with the bearing shell.

In a further development, the connecting section is made from at least one shaped sheet-metal element. In particular, an aluminum sheet is used as the metal sheet. The connecting section can comprise a first connecting area for connecting to the pendulum support and a second connecting area for connecting to the stabilizer body. The connecting section functions as an interface between the stabilizer body and the pendulum support, while the connecting section can, at the same time, serve to transmit force between the stabilizer body and the pendulum support. The connecting section can be made in one piece. Preferably, the connecting section is made from more than one piece.

In particular, the first connecting area comprises the opening for receiving the bearing shell. Here, the said first connecting area can be essentially flat, planar or even. Moreover, at least the first connecting area can be single-layered. That enables simple and inexpensive production from a metal sheet, so that at least to form the first connecting area no complex deformations are needed. Preferably, the first connecting area has bent-up rims in order to stiffen the connecting section, in particular the first connecting area. The said bent-up rims can extend transversely or perpendicularly to a surface of the first connecting area that contains the opening. Such bent-up rims can be produced comparatively easily by a suitable deformation process, and they result in substantial stiffening. The bent-up rim areas can extend from the first connecting area to the second connecting area.

In particular, the second connection area is of tube-shaped and/or tubular form. In this case, an inside diameter of the second connection area can correspond to an outside diameter of an end of the stabilizer body. The inside diameter of the second connection area and the outside diameter of the stabilizer body can then match one another so that the second connection area can be plugged onto the free end of the stabilizer body in a form-enclosing manner. Preferably, the second connection area has at least one securing element for forming the snap-in and/or latch joint with the stabilizer body. In particular, the said securing element is made elastically deformable. An advantageous design provides that the securing element is designed as a snap-tongue and/or a retaining hook. Such a securing element can engage in a suitably designed holding structure of the stabilizer body in order to prevent the connecting section from being detached from the stabilizer body. With an elastically deformable securing element, this will be deformed during the joining process so that when the joining process is completed, an interlocked connection, between the connecting section and the stabilizer body, is formed by spring-back (“snap-in”, or “latching”). Preferably, this takes place as the securing element hooks or latches into a holding structure formed on the stabilizer body. Depending on the design and in particular the accessibility of the securing element from outside, it can be possible to undo the snap-in and/or latch joint again, so that a releasable joint is provided. The holding structure of the stabilizer body can be in the form of a depression in the stabilizer body that corresponds to the securing element. In particular, the second connecting area and the end of the stabilizer body can have matching contours and/or sections, which, by virtue of their co-operation, prevent any twisting and/or rotation of the connecting section about the end of the stabilizer body. The end of the stabilizer body can also be called the ‘stabilizer body end’.

According to a further development, the connecting section is formed from a first sheet-metal element and a second sheet-metal element. In particular, the first sheet-metal element forms the first connecting area for joining to the pendulum support. Thus, the first sheet-metal element has the opening for receiving the bearing shell. Preferably, the second connecting area is designed to be connected to the stabilizer body by virtue of a combination of the first sheet-metal element and the second sheet-metal element. The tube-shaped or tubular form of the second connecting area can be produced by virtue of the said combination of the first sheet-metal element and the second sheet-metal element. Thus, the first sheet-metal element can be designed in its first part to form the first connecting area on the one hand, and the second sheet-metal element can, on the other hand, be in the form of a half-shell.

Preferably, the first sheet-metal element and the second sheet-metal element are connected to one another in a material-merged manner. In particular, the first sheet-metal element and the second sheet-metal element are joined to one another by welding. Thus, the first sheet-metal element and the second sheet-metal element are permanently joined together. The two sheet-metal elements can be prefabricated separately or independently of one another, and in particular in that way, by means of the two sheet-metal elements the tubular form of the second connecting area is simpler to produce. Preferably, the first sheet-metal element and the second sheet-metal element have contact webs that correspond with one another. The contact webs can, at the same time, be rim sections of the first sheet-metal element and/or of the second sheet-metal element. Preferably, the first sheet-metal element comprises the contact webs in the section for forming the first connecting area. The contact webs of the second sheet-metal element can extend over the full length of the second sheet-metal element. The contact webs of the two sheet-metal elements can be in contact with one another and be joined to one another in a material-merged manner. Such contact webs can be produced simply by a suitable deformation of the sheet-metal elements. By virtue of the contact webs, a sufficiently large area of contact between the two sheet-metal elements can be produced, which favors the production of a cohesive joint.

According to a further development, the connecting section has a stop to limit a plug-on movement for plugging the connecting section onto an end of the stabilizer body, in particular, in order to produce the snap-in and/or latch connection. In particular, the stop, the securing element and the holding structure are matched to one another in such a manner that when the securing element reaches the stop, it latches and/or snaps into the holding structure. The stop can be in the form of a bent up sheet tab. Such a stop can be produced simply and effectively by a suitable deformation. In particular, the stop is associated with or arranged on the second sheet-metal element. Preferably, the stop extends on the second sheet-metal element in the direction toward the first sheet-metal element. In that case, the stop can be arranged on a side of the second sheet-metal element that faces toward the connecting section.

To be arranged on a stabilizer, in particular in accordance with the forgoing description, a pendulum support, according to the invention, is connected to a connecting section which is made of a metal and is designed to be connected to the stabilizer body by means of a snap-in and/or latch connection. In this case, the connecting section has an opening in which a plastic bearing shell is arranged for the mobile fitting of a joint ball of the pendulum support.

Particularly advantageous is a method for producing a stabilizer according to the invention and/or a pendulum support according to the invention. In this method, the connecting section is arranged in an injection-molding die and the bearing shell is produced by an injection-molding process. During its production or injection-molding, the bearing shell is, at the same time, arranged and, in particular, fixed in the opening of the connecting section. Thus, after the injection-molding of the bearing shell a hybrid components is produced, comprising the metallic connecting section and the plastic bearing shell. In particular, the bearing shell is restricted to the area of the opening in the connecting section. Preferably, apart from the formation of the bearing shell, the connecting section is not overmolded with any more of the plastic. Thus, the use of plastic is limited to the formation of the bearing shell.

Preferably, at least the joint ball, in particular the pendulum support and/or a joint pin of the pendulum support, is arranged in the injection-molding die together with the connecting section. In this case the joint ball is located in the opening of the connecting section. The bearing shell is produced by the injection-molding process, whereby the bearing shell is joined, at the same time, to the connecting section and the joint ball is held in the bearing shell. In particular, during injection-molding plastic is injected between the rim of the opening and the joint ball to form the bearing shell. After the injection-molding process and the extraction from the injection-molding die, the pendulum support can, if necessary, be finish-processed. The pendulum support can comprise a connection component at an end remote from the connecting section. At the end of the pendulum support or connection component, remote from the connecting section, a further articulated joint can be arranged. The connection component and/or the further articulated joint of the pendulum support can be connected to a chassis component, for example a wheel carrier or a control arm. The connecting section and the pendulum support can be prefabricated as an assembly. This assembly can be connected to the stabilizer body by the snap-in and/or latch joint.

In particular, a connecting area of the connecting section is plugged onto an end of the stabilizer body to form the snap-in and/or latch connection, wherein at least one securing element of the connecting section latches and/or snaps into a holding structure of the stabilizer body.

In particular, the stabilizer and/or the pendulum support produced, according to the invention, is/are a stabilizer and/or a pendulum support as described earlier, produced in accordance with the method according to the invention. Preferably, the method is developed further in accordance with all the features explained in connection with the stabilizer and/or the pendulum support, according to the invention, described herein. Furthermore, the stabilizer or the pendulum support described herein can be developed further in accordance with all the features explained in connection with the said method.

### BRIEF DESCRIPTION OF THE DRAWINGS

Below, the invention is explained in greater detail with reference to the figures. In these, the same indexes denote the same, similar, or functionally equivalent components or elements. The figures show:

FIG. 1: A perspective front view of a stabilizer according to the invention,

FIG. 2: A detail from the perspective front view of a stabilizer according to the invention, shown in FIG. 1,

FIG. 3: A sectioned side view of the detail shown in FIG. 2,

FIG. 4: A perspective side view of two sheet-metal elements for forming a connecting section for a stabilizer according to the invention, as shown in FIGS. 1 to 3,

FIG. 5: A perspective side view of the connecting section shown in FIG. 4, before being connected to a joint ball of a pendulum support,

FIG. 6: A perspective side view of the connecting section shown in FIG. 5, after being connected to a joint ball of a pendulum support,

FIG. 7: A perspective side view of a second connecting section,

FIG. 8: A sectioned perspective side view of the second connecting section shown in FIG. 7, and

FIG. 9: A perspective side view of a further connecting section.

### DETAILED DESCRIPTION OF THE PREFERRED EMBODIMENTS

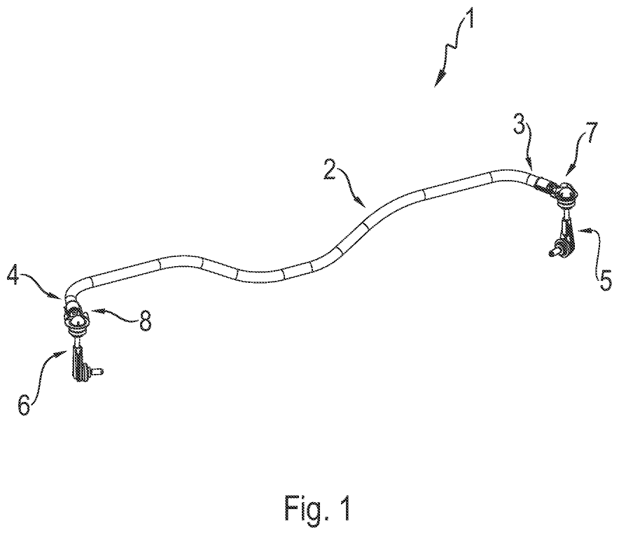

FIG. 1 shows a perspective front view of a stabilizer 1 according to the invention. This is a torsion spring device loaded in torsion, which can be used in the chassis of a vehicle for avoiding rolling movements of the vehicle. The stabilizer 1 has a stabilizer body 2. The stabilizer body 2 is in the form of a bar or rod. Moreover, the stabilizer body is curved. In this case, two ends of the stabilizer body 2 or two stabilizer body ends 3, 4, remote from one another, are arranged so that the stabilizer body 2 is essentially U-shaped. At the same time, the two stabilizer body ends 3, 4 form the limbs of the essentially U-shaped design of the stabilizer body 2. In this example embodiment, the stabilizer body 2 is made from a fiber-reinforced plastic or a fiber-reinforced plastic composite. For example, continuous glass or carbon fibers can be used as the fiber material, which are embedded in a duroplastic or thermoplastic matrix. In this case, the stabilizer body 2 can be made hollow or tubular, or made from solid material.

The stabilizer 1 has two pendulum supports 5, 6. In this case, the pendulum support 5 is associated with the stabilizer body end 3 and the pendulum support 6 with the stabilizer body end 4.

Furthermore, the stabilizer 1 has two connecting section 7, 8. Here, the connecting section 7 is associated with the stabilizer body end 3 and the connecting section 8 with the stabilizer body end 4. In detail, the connecting sections 7, 8 are respectively arranged between the stabilizer body ends 3 and 4 and the associated pendulum supports 5 and 6. Thus, the connecting sections 7, 8 serve, as it were, as an interface for force transfer and/or for forming a connection between the stabilizer body 2 and the respective pendulum supports 5 and 6.

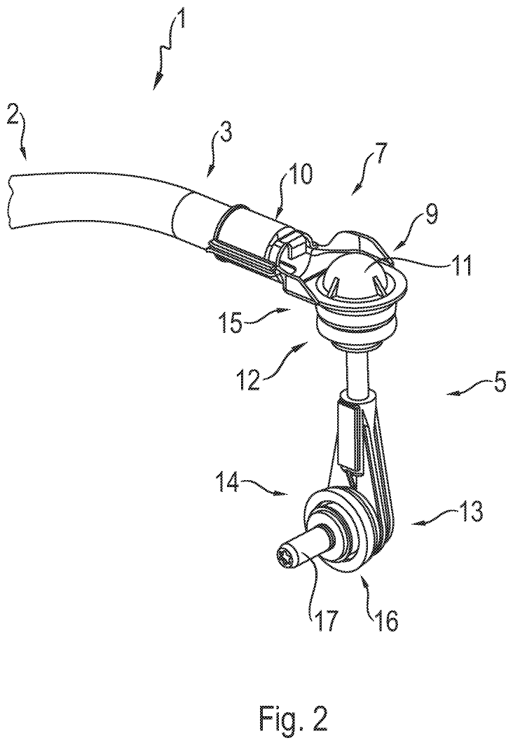

FIG. 2 shows a detail of the perspective front view of the stabilizer 1 according to the invention shown in FIG. 1. To be specific, the stabilizer body end 3 with the pendulum support 5 and the connecting section 7 are shown in this case. The following explanations of this also analogously apply to the stabilizer body end 4, the pendulum support 6 and the connecting section 8.

The connecting section 7 has a first connecting area 9. The connecting section 7 is joined to the pendulum support 5 by means of this first connecting area 9. Moreover, the connecting section 7 has a second connecting area 10. The connecting section 7 is joined to the stabilizer body end 3 by means of the second connecting area 10. Here, the connecting section 7 or the second connecting area 10 is connected to the stabilizer body end 3 with interlock, by virtue of a snap-in and/or latch joint (not shown). For this, the second connecting area 10 is plugged onto the stabilizer body end 3.

The first connecting area 9 and the second connecting area 10 together form the connecting section 7 and merge directly or integrally into one another. In the longitudinal direction of the connecting section 7, the two connecting areas 9, 10 form two ends of the connecting section 7 that face away from one another. The connecting section 7 is made from a metal, in this example embodiment aluminum.

In the first connecting area 9 the connecting section 7 has a bearing shell 11. The bearing shell 11 is made of a plastic and is firmly connected to the first connecting area 9. A first end 12 of the pendulum support 5 is fitted in the bearing shell 11 in an articulated manner. A second end 13 of the pendulum support 5, remote from the first end 12, has a connection component 14. The connection of the first end 12 to the connecting section 7 is in the form of an articulated joint 15. In this example embodiment, the articulated joint 15 is in the form of a ball joint 15. In the area of the second end 13, a further articulated joint 16 is provided. In this example embodiment, the said further articulated joint 16 is also in the form of a ball joint. In this case, according to the example embodiment shown here, a pin section 17 extends out of the connection component 14. The pin section 17 can be connected to a chassis component (not shown), for example a wheel carrier or a control arm.

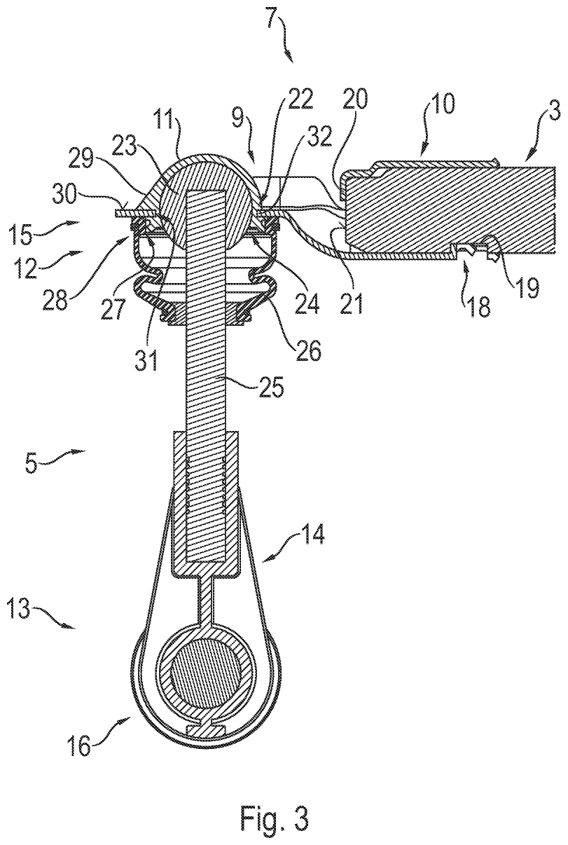

FIG. 3 shows a sectioned side view of the detail according to FIG. 2. The second connecting area 10 is tubular. An inner diameter or inner contour of the second connecting area 10 is made to match an outer diameter or outer contour of the stabilizer body end 3, with a view to forming a form-enclosing joint.

The connecting section 7 or second connecting area 10 has an elastically deformable securing element 18. In this example embodiment, the securing element 18 is in the form of a snap-in or latching hook. The stabilizer body end 3 has a holding structure 19 designed to co-operate with the securing element 18. In this example embodiment, the holding structure 19 is in the form of a depression in the outer surface of the stabilizer body end 3. By virtue of the co-operation of the securing element 18 and the holding structure 19, the snap-in and/or latch joint of the connecting section to the stabilizer body 2 is formed. For this, the securing element 18 is latched or snapped into the holding structure 19.

Furthermore, the connecting section 7 has a stop 20. By means of the stop 20 a plug-on movement of the connecting section 7, for plugging the second connecting area 10 onto the stabilizer body end 3, is limited. In this example embodiment, the stop 20 is arranged on the second connecting area 10. In this case, a front face 21 of the stabilizer body end 3 encounters the stop 20. Here, the stop 20 is in the form of a bent-up sheet tab.

In the first connecting area 9, the connecting section 7 has an opening 22. The bearing shell 11 is fitted into the said opening 22. The outside and the inside of the bearing shell 11 are essentially in the shape of a spherical section. Within the bearing shell 11 a joint ball 23 is fitted and can move. In this case, the bearing shell 11 surrounds the joint ball 23 in such a manner that the joint ball 23 is securely held inside the bearing shell 11.

The bearing shell 11 has a bearing shell opening 24, out of which part of the joint ball 23 and a joint pin 25, attached to the joint ball 23, extend. The joint pin 25 connects the first end 12 of the pendulum support 5 to the second end 13 thereof. A sealing bellows 26 is associated with the first end 12. The articulated joint 15 is protected against environmental influences by means of the sealing bellows 26. In this example embodiment, the bearing shell 11 has, on a side facing toward the sealing bellows 26, a holding groove 27. A sealing bellows rim 28 of the sealing bellows 26 is arranged and held in the holding groove 27.

On a side facing away from the pendulum support 5, the bearing shell 11 has a plurality of stiffening ribs 29. In the sectioned representation shown here, only one stiffening rib 29 can be seen. The stiffening rib 29 is supported on a side or surface 30 of the connecting section 7 that faces away from the pendulum support 5.

The bearing shell 11 has a groove-like slot 31 for receiving a rim 32 of the opening 22. Thus the bearing shell 11 grips the rim 32 so that the bearing shell 11 is held onto the opening 22 or the rim 32 in a form-enclosed manner.

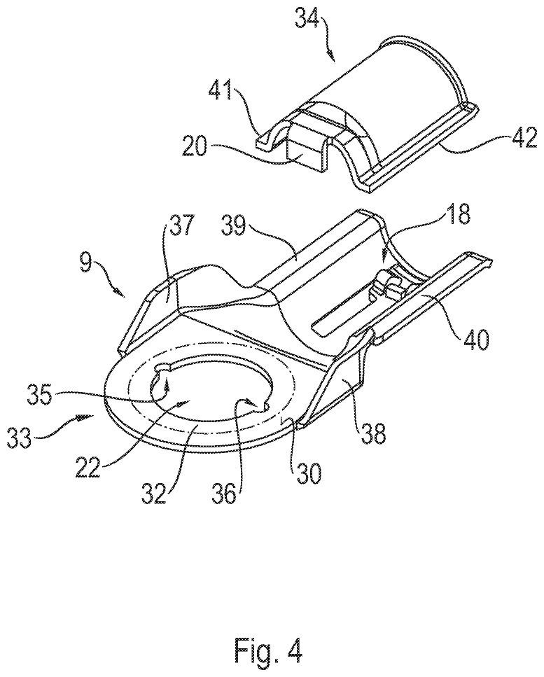

FIG. 4 shows a perspective side view of two sheet-metal elements 33, 34 for forming the connecting section 7 or 8 for the stabilizer 1 according to FIGS. 1 to 3. The first sheet-metal element 33 comprises the first connecting area 9. In this representation, the bearing shell 11 has not yet been fitted into the opening 22 as it is in FIGS. 1 to 3. The rim 32 of the opening 22 is essentially circular.

In this example embodiment, the rim 32 has notches 35 and 36. In particular, the notches 35, 36 are in the form of cut-outs in the rim 32. In this case, as an example, the notches 35, 36 are formed opposite or mirror-symmetrically relative to one another. While the bearing shell 11 is being made and arranged as in FIGS. 2 and 3, the plastic of the bearing shell 11 penetrates into the notches 35, 36. This prevents or blocks any twisting or rotation of the bearing shell 11 about the mid-point of the opening 22.

The first sheet-metal element 33 has two bent-up rim areas 37, 38. In this example embodiment, the bent-up rim areas 37, 38 extend perpendicularly to the surface 30 of the first connecting area 9 in which the opening 22 is arranged. The bent-up rims areas 37, 38 stiffen the first sheet-metal element 33 and the connecting section 7, particularly, in the first connecting area 9.

The second connecting area 10 of the connecting section 7, shown in FIGS. 2 and 3, is formed by virtue of a combination or co-operation of the two sheet-metal elements 33, 34. To produce the tubular second connecting area 10, the second sheet-metal element 34, and a section of the second sheet-metal element 34 provided for forming the second connecting area 10, are in each case designed as a half-shell. The first sheet-metal element 33 has contact webs 39, 40 in the section for forming the second connecting area 10. For this, the second sheet-metal element 34 has contact webs 41, 42 designed to correspond with the said webs 39, 40. In this case, the contact webs 39 to 42 each, at the same time, form a rim section.

To form the connecting section 7 shown in FIGS. 2 and 3, the two sheet-metal elements 33 and 34 are positioned one over the other in such a manner that the contact webs 39 to 42 are in contact with one another. In detail, here, on the one hand, the contact webs 39 and 41 and, on the other hand, the contact webs 40 and 42 are in contact. Then, the first sheet-metal element 33 and the second sheet-metal element 34 are joined in a material-merged way, for example by a welded joint. The material-merged connection is made in the area of the contact webs 39 to 42.

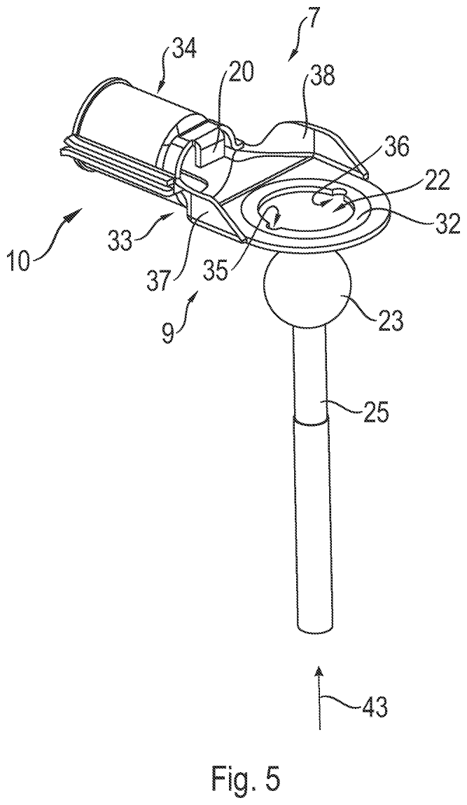

FIG. 5 shows a perspective side view of the connecting section 7 after the two sheet-metal elements 33 and 34 have been joined together, as in FIG. 4, but before the connection to the joint ball 23 of the pendulum support 5. To produce the stabilizer 1 and the pendulum support 5 in combination with the connecting section 7, the connecting section 7 together with the joint ball 23 are arranged in an injection-molding die (not shown). In this example embodiment, the joint ball 23 is connected to the joint pin 25. As indicated by the arrow 43, the joint ball 23 is inserted into the opening 22 of the connecting section 7. The connecting section 7 and the joint ball 23 are positioned relative to one another in such a manner that those components are orientated relative to one another as illustrated in FIG. 3. After the connecting section 7 and the joint ball 23 have been so arranged in the injection-molding die, the bearing shell 11 is made by an injection-molding process. In this case, the bearing shell 11 is, at the same time, arranged or injection-molded in the opening 22 and on the rim 32 of the connecting section 7.

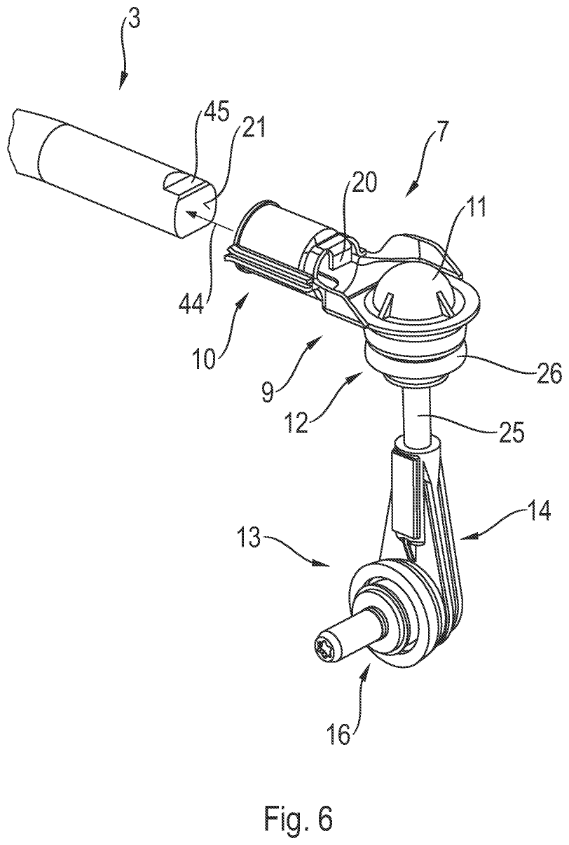

FIG. 6 shows a perspective side view of the connecting section 7, as in FIG. 5, after its connection to the joint ball 23 of the pendulum support 5. Correspondingly, the bearing shell 11 is here formed by the injection-molding process. It can also be seen that, after the injection-molding of the bearing shell 11, the pendulum support 5 has been completed. In addition, the connecting component 14 is formed with the articulated joint 16 at the second end 13 of the pendulum support 5. Thus, the pendulum support 5 in combination with the connecting section 7 form an assembly. This assembly comprising the connecting section 7 and the pendulum support 5 is then plugged onto the stabilizer body end 3, as indicated by the arrow 44. For this, the second connecting area 10 is pushed onto the stabilizer body end 3 far enough for the front 21 of the stabilizer body end 3 to encounter the stop 20 and for the securing element 18 to latch or snap into the holding structure 19, shown in FIG. 3, to form the snap-in and/or latch connection.

The stabilizer body end 3 has a flattened area 45 on its outer periphery. The flattened area 45 co-operates with a correspondingly shaped inner contour of the second connecting area 10 of the connecting section 7. Thereby a rotation-opposing feature is formed, which prevents any relative movement of the connecting section 7 in the circumferential direction about the stabilizer body end 3.

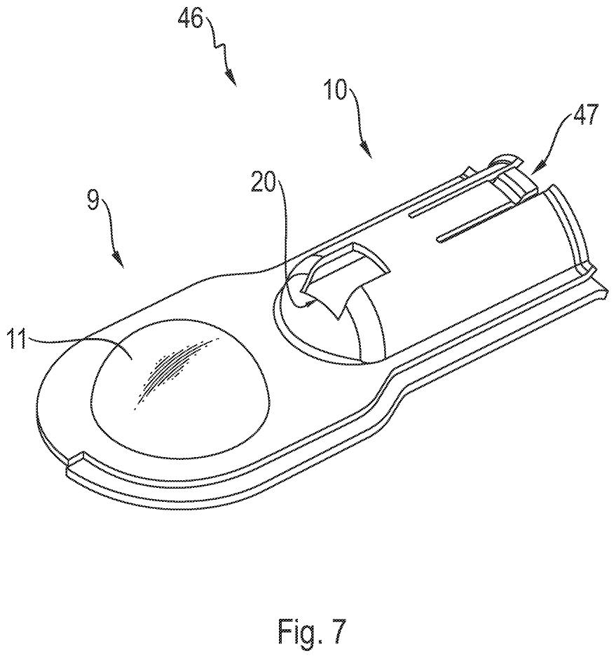

FIG. 7 shows a perspective side view of a second connecting section 46. The second connecting section 46 can be used as an alternative to the connecting section 7 or 8 shown in the previous FIGS. 1 to 6. The essential structure of the second connecting section 46 corresponds to the structure of the connecting section 7 or 8. Accordingly, reference should be made to the previous description. The same features as before are given the same indexes.

An essential difference is that the connecting section 46 is formed from a single sheet-metal element. In this case, the sheet metal of the connecting section 46 is deformed in such a manner that the connecting section 46 is produced in a double layer in the first connecting area 9.

Furthermore, in this second connecting section 46, the second connecting area 10 has a second securing element 47. The second securing element 47 is formed correspondingly or mirror-symmetrically to the securing element 18, shown in FIGS. 3 and 4.

As an example, the bearing shell 11 is, in this case, shown without stiffening ribs 29. Alternatively, the bearing shell 11 for the second connecting section 46 can have stiffening ribs, as in the embodiment shown in FIGS. 2 and 3.

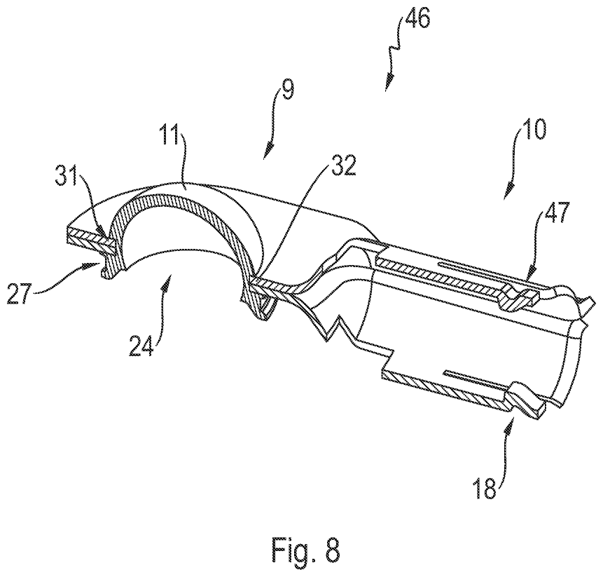

FIG. 8 shows a sectioned perspective side view of the second connecting section 46 shown in FIG. 7. It is easy to see the double-layered structure of the sheet-metal element for forming the connecting section 46 in the first connecting area 9. Furthermore, it is easy to see that the two securing elements 18 and 47 are arranged opposite one another or mirror-symmetrically relative to one another.

In FIGS. 7 and 8, the second connecting section 46 is shown with the bearing shell 11, but without the joint ball 23. In fact, however, when the bearing shell 11 has been formed the joint ball 23 is movably arranged within it. In this case, the bearing shell 11 and the connection between the joint ball 23 and the second connecting section 46, by means of the bearing shell 11, are produced in accordance with the method explained with reference to FIGS. 5 and 6. Owing to the omission of the joint ball 23, the structure of the bearing shell 11 and the co-operation with the first connecting area 9, as already explained with reference to the previous FIGS. 2 to 6, can be seen clearly.

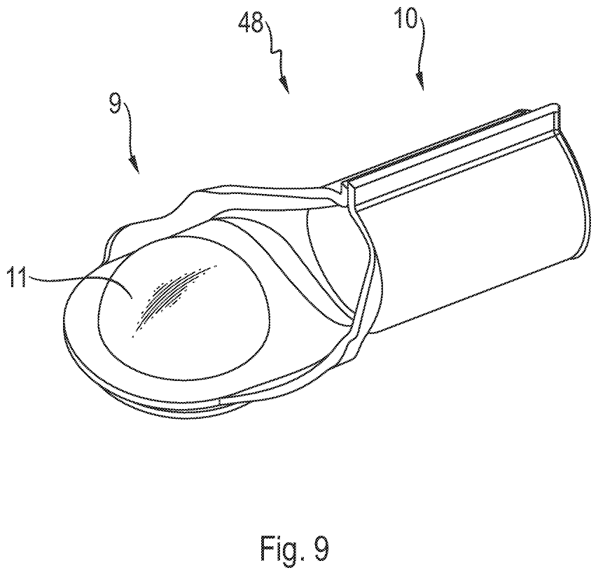

FIG. 9 shows a perspective side view of a further connecting section 48. This further connecting section 48 corresponds in its structure essentially to the previously described connecting sections 7, 8 and 46. Accordingly, reference should again be made to the previous description. The same features as before are given the same indexes. As already in the second connecting section 46 shown in FIGS. 7 and 8, the said further connecting section 48 too is formed from a single sheet-metal element. In this case, however, the sheet metal of the further connecting section 48 is shaped in such a manner that in the first connecting area 9 it has a single-layered structure. For the sake of greater clarity, in this representation too the joint ball 23 has been omitted.

### INDEXES

1 Stabilizer
2 Stabilizer body
3 Stabilizer body end
4 Stabilizer body end
5 Pendulum support
6 Pendulum support
7 Connecting section
8 Connecting section
9 First connecting area
10 Second connecting area
11 Bearing shell
12 First end
13 Second end
14 Connecting component
15 Articulated joint
16 Articulated joint
17 Pin section
18 Securing element
19 Holding structure
20 Stop
21 Front face
22 Opening
23 Joint ball
24 Bearing shell opening
25 Joint pin
26 Sealing bellows
27 Holding groove
28 Sealing bellows rim
29 Stiffening rib
30 Surface
31 Groove-like seating
32 Rim
33 First sheet-metal element
34 Second sheet-metal element
35 Notch
36 Notch
37 Bent-up rim area
38 Bent-up rim area
39 Contact web
40 Contact web
41 Contact web
42 Contact web
43 Arrow
44 Arrow
45 Flattened area
46 Second connecting section
47 Securing element
48 Further connecting section

1-14. (canceled)

15. A stabilizer for a chassis of a vehicle comprising:
a curved stabilizer body (2) that forms a torsion spring, with a pendulum support (5, 6) and with a connecting section (7, 8, 46, 48), and
the said connecting section (7, 8, 46, 48) being made of a metal and connecting the stabilizer body (2) to the pendulum support (5, 6),
wherein the connecting section (7, 8, 46, 48) and the stabilizer body (2) are connected to one another by a snap-in and/or latch joint, and
the connecting section (7, 8, 46, 48) has an opening (22) in which a plastic bearing shell (11) is arranged for the movable fitting of a joint ball (23) of the pendulum support (5, 6).

16. The stabilizer according to claim 15, wherein the bearing shell (11) is held in a form-enclosed manner on a rim (32) of the opening (22), and the rim (32) of the opening (22) is of circular shape, and the rim (32) of the opening (22) has at least one notch (35, 36) into which the plastic of the bearing shell (11) extends.

17. The stabilizer according to claim 15, wherein the bearing shell (11) has a bearing shell opening (24), out of which the pendulum support (5, 6) and the joint ball (23) and/or a joint pin (25) connected to the joint ball (23) extends, and a rim of the bearing shell opening (24) has an all-round holding groove (27) for holding a sealing bellows rim (28).

18. The stabilizer according to claim 15, wherein the bearing shell (11) has a plurality of stiffening ribs (29) on its outer circumference, which ribs are supported on the connecting section (7, 8, 46, 48), and the stiffening ribs (29) are arranged on a side (30) of the bearing shell (11) and/or the connecting section (7, 8, 46, 48) which faces away from the bearing shell opening (24).

19. The stabilizer according to claim 15, wherein the connecting section (7, 8, 46, 48) is made from at least one shaped sheet-metal element (33, 34), and the connecting section (7, 8, 46, 48) has a first connecting area (9), for connection to the pendulum support (5, 6), and a second connecting area (10), for connection to the stabilizer body (2).

20. The stabilizer according to claim 19, wherein the first connecting area (9) contains the opening (22) for receiving the bearing shell (11), and the first connecting area (9) is substantially flat and/or the first connecting area (9) has bent-up rim areas (37, 38) for stiffening the connecting section (7, 8, 46, 48).

21. The stabilizer according to claim 19, wherein the second connecting area (10) is of tubular form, and the second connecting area (10) comprises at least one elastically deformable securing element (18, 47) for forming the snap-in and/or latch joint with the stabilizer body (2).

22. The stabilizer according to claim 15, wherein the connecting section (7, 8, 46, 38) is made from a first sheet-metal element (33) and a second sheet-metal element (34), and the first sheet-metal element (33) forms a first connecting area (9), for connection to the pendulum support (5, 6), whereas a second connecting area (10) for connection to the stabilizer body (2) is formed by a combination of the first sheet-metal element (33) and the second sheet-metal element (34).

23. The stabilizer according to claim 22, wherein the first sheet-metal element (33) and the second sheet-metal element (34) are permanently connected to one another in a material-merged manner by welding, and the first sheet-metal element (33) and the second sheet-metal element (34) have contact webs (39, 40, 41, 42) that correspond with one another, which are in contact with one another and are connected to one another in a material-merged manner.

24. The stabilizer according to claim 15, wherein the connecting section (7, 8, 46, 48) has a stop (20) for limiting a plug-on movement for plugging the connecting section (7, 8, 46, 48) onto an end of the stabilizer body (2), and the stop (20) is in the form of a bent-up sheet-metal tab.

25. A pendulum support for the stabilizer according to claim 15, with the connecting section (7, 8, 46, 48), the connecting section (7, 8, 46, 48) is made of a metal and is designed for connection to the stabilizer body (2) by a snap-in and/or latch joint, and the connecting section (7, 8, 46, 48) has an opening (22) in which a plastic bearing shell (11) is arranged for the movable fitting of a joint ball (23) of the pendulum support (5, 6).

26. A method for producing the stabilizer according to claim 15, wherein the connecting section (7, 8, 46, 48) is arranged in an injection-molding die and the bearing shell (11) is made from plastic by an injection-molding process and is, at the same time, arranged in the opening (22) of the connecting section (7, 8, 46, 48).

27. The method according to claim 26, wherein together with the connecting section (7, 8, 46, 48), at least the joint ball (23) and the pendulum support (5, 6) and/or a joint pin (25) of the pendulum support (5, 6) is arranged in the injection-molding die,
the joint ball (23) is arranged in the opening (22) of the connecting section (7, 8, 46, 48), and
the bearing shell (11) is made by the injection-molding process while, at the same time, the bearing shell (11) is connected to the connecting section (7, 8, 46, 48) and the joint ball (23) is held in the bearing shell (11).

28. The method according to claim 26, wherein a connecting area (10) of the connecting section (7, 8, 46, 48) is plugged onto an end of the stabilizer body (3, 4) in order to form the snap-in and/or latch joint, and at least one securing element (18, 47). of the connecting section (7, 8, 46, 48). latches and/or snaps into a holding structure (19) of the stabilizer body (2).

29. A method for producing the pendulum support according to claim 26, wherein the connecting section (7, 8, 46, 48) is arranged in an injection-molding die and the bearing shell (11) is made from plastic by an injection-molding process and is, at the same time, arranged in the opening (22) of the connecting section (7, 8, 46, 48).
